(19) United States
(12) Patent Application Publication
(10) Pub. No.: US 2023/0306065 A1
(43) Pub. Date: Sep. 28, 2023

(54) Document Generator

(71) Applicants: Chetan Desh, Bellevue, WA (US); Pradnya Desh, Bellevue, WA (US)

(72) Inventors: Chetan Desh, Bellevue, WA (US); Pradnya Desh, Bellevue, WA (US)

(21) Appl. No.: 17/730,152

(22) Filed: Apr. 26, 2022

Related U.S. Application Data
(60) Provisional application No. 63/323,006, filed on Mar. 23, 2022.

(51) Int. Cl. G06F 16/93; G06F 16/953; G06F 16/951

(52) U.S. Cl. CPC G06F 16/93; G06F 16/953; G06F 16/951

(57) ABSTRACT

Document generation systems may receive a user request from a user to generate a document. For example, the document to be generated by a document generation system may generate the document based on the intent expressed within the user request. The document generation system may generate the document based on structured information that describes the type of document to be generated, for example.

### FIELD

This disclosure relates generally to document generation.

### BACKGROUND

Computing systems are used to generate documents that relate to multiple entities. Protection of the intellectual properties of respective entities is of limited scope and is subject to an increasing variety of exploits performed by other parties for the purpose of expropriating intellectual property that may be otherwise protected.

### SUMMARY

The instant application discloses, among other things, document generator systems, which may be computer components configured to generate documents based on input from multiple entities. Document generators may be configured to communicate electronically with a client device of a user so as to give the user an interactive or personalized experience. Document generators may generate a document based on hierarchical schemas of documents to be generated. A user may verbally (or otherwise) indicate an intended outcome or accomplishment to a document generator, for example, and in response the document generator may determine values for lexical units (e.g., parts of speech such as nouns and verbs) to be included in the document being generated based on the schemas and lexical units used to describe the intended type of document. The document generator may query an entity different from the user to obtain values (e.g., based on relationships within the schemas and lexical units) for inclusion within a document being generated according to the indicated type of document.

Document generators may include communication ports by which devices of multiple entities may communicate with a document generator. A document generator may be communicatively coupled to remote clients and systems using various networks coupled to other networks such as local networks or the Internet. The coupled-to networks may include processing elements configured to execute services in containers for document generation. According to one embodiment, document generators may include a server configured to communicate electronically (e.g., using an Internet Protocol) with each device of a respective entity. Each of the devices of multiple parties may have cabled, cellular, Radio-Frequency Identification (RFID), Wi-Fi, Bluetooth, or Near-Field Communication (NFC) capabilities that may be communicably coupled to local networks or the Internet, for example. This disclosure relates generally to electronic document generation.

### BRIEF DESCRIPTION OF THE DRAWINGS

Networked computing systems may serve as document generation tools for multiple entities. Many networked computing systems are limited in scope in terms of the ability to easily and securely to generate documents based on input from multiple entities.

FIG. 1 illustrates Document Generator Network 100, according to one embodiment.

FIG. 2 illustrates Document Generator System 200, according to one embodiment.

FIG. 3 illustrates Knowledge Graph 300 including schemas and lexical units, according to one embodiment.

FIG. 4 illustrates Signal Flows 400 for generating a document, according to one embodiment.

FIG. 5 illustrates Document Template System 500 for generating a document, according to one embodiment.

FIG. 6 illustrates Document Generator Process 600 for securely generating a document having multiple parties, according to one embodiment.

FIG. 7 is a component diagram of computing system 700 to which a process described herein may be applied according to one embodiment.

FIG. 8 illustrates high-level Document Generator Process 800 according to another embodiment.

Like reference numerals are used to designate like parts in the accompanying drawings.

### DETAILED DESCRIPTION

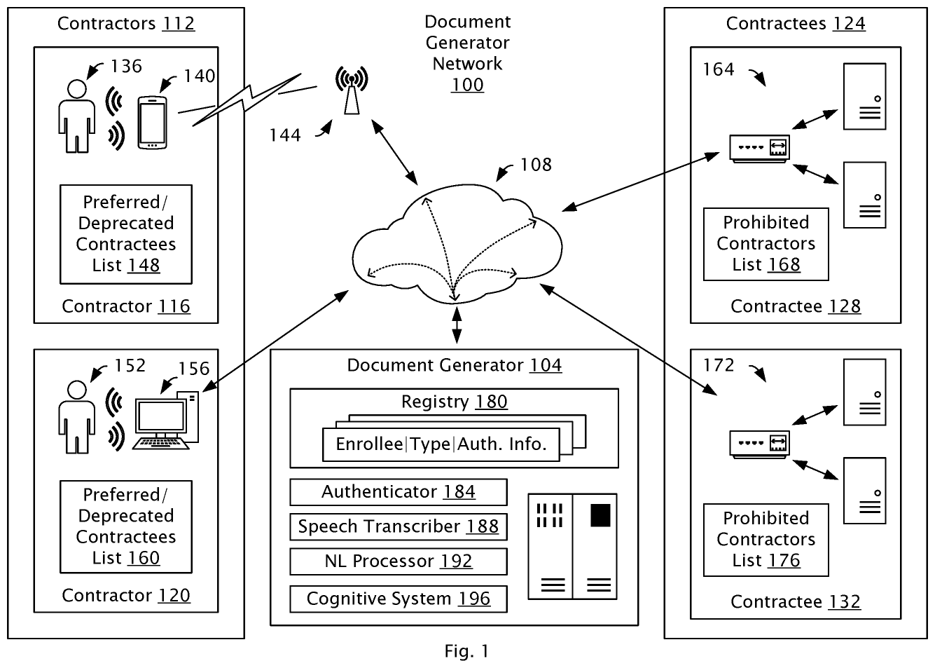

FIG. 1 illustrates Document Generator Network 100, according to one embodiment. Document Generator Network 100 may include Document Generator 104. Document Generator 104 may be communicably coupled to Network 108 (such as a network including remotely distributed processing elements such as containers), which in turn may be coupled (directly or indirectly) to Contractors 112 (such as Contractor 116 and Contractor 120) and to Contractees 124 (such as Contractee 128 and Contractee 132). Document Generator 104 may subdivide its tasks into processing portions and send selected processing portions to various processing elements (local or remote) for shared or parallel execution.

Document Generator 104 may be arranged to communicate with Contractors 112 and Contractees 124 via Internet 108 to generate documents based on values (e.g., terms) and information provided by respective parties of the Contractors 112 and Contractees 124. Contractor 116 may be User 136 operating Device 140 (e.g., a cell phone having a thin client coupled to Internet 108 via Cellular Service Provider 144) that includes Preferred/Deprecated Contractees List 148. Similarly, Contractor 120 may be User 152 operating Device 156 (e.g., a desktop computer having a thin client) that includes Preferred/Deprecated Contractees List 160. Contractee 128 may include Networked System 164 (which may be networked computing system of a commercial business), which includes Prohibited Contractors List 168. Similarly, Contractee 132 may include Networked System 172 (which may be networked computing system of a commercial business), which includes Prohibited Contractors List 176.

Document Generator 104 may be a server, which may include (e.g., instantiate) Registry 180, Authenticator 184, Speech Transcriber 188, Natural Language (NL) Processor 192, and Cognitive System 196. Providing computing components for the authentication, transcription, and natural language processing of speech as components located within Document Generator 104 allows clients to be “thin,” which may decrease overall costs while increasing overall security. For example, the authentication, transcription, and natural language processing of speech are relatively expensive, highly trained, highly complex, and memory- and processing-intensive functions. Co-locating and executing these functions within Document Generator 104 allows these functions to be provisioned in a single server system (e.g., for which enhanced measures for physical and networking security may be more securely and efficiently implemented).

Each of Authenticator 184, Speech Transcriber 188, Natural Language Processor 192, and Cognitive System 196 may be used to enroll Contractors 112 and Contractees 124 in Registry 180. For example, the enrollment process may include obtaining registration information for listing enrollees (e.g., name, address, and various business information), type of enrollee (e.g., contractor or contractee) and capturing authentication information (which may be “Auth. Info” such as passwords, user response timing, gestures, voiceprints, video, images, device fingerprinting for hardware authentication, and other quantified performance characteristics for identifying a user). Registry 180 may optionally store business information such as inventory, service/product types, and contract terms (e.g., payment terms). After enrolling a pair of Contractors 112 and Contractees 124, Document Generator 104 serves as an intermediary agent for transferring and routing each communication (e.g., all communications) between any two of Contractors 112 and Contractees 124.

In an example, Document Generator 104 may receive a user request generated by User 136, where the user request may indicate a type of document to be generated (e.g., a sales contract) on behalf of User 136. The generated user request may include (e.g., be associated with) quantifiable performance characteristics used to generate the user request. The quantifiable performance characteristics may include physical actions, which may be evaluated in time, space, frequency, acoustic, and image domains (and combinations thereof). The physical actions may include User 136 speech formants and patterns, facial characteristics and changes (e.g., based on User 136 being told to “Smile!”), keystroke cadences and other ideosyncratic characteristics for authenticating User 136. Such authentication may include evaluating and comparing quantifiable performance characteristics of the user request against the quantifiable performance characteristics previously determined to be manifested by User 136 during a secure session (e.g., during enrollment of a particular user authorized by a contractor or contractee). Authenticator 184 may be (or may include) a machine learning-based model that is trained based on performance characteristics captured during a secure enrollment session of a particular user.

Authenticating the speech (and the concomitant performance characteristics thereof) of the actual received user request as speech that is affirmed to be spoken by User 136 helps prevent deceptive exploits such as person-in-the-middle, machine-generated speech, spoofing, and replay attacks. Person-in-the-middle attacks may be detected based a rule that a verbal request made by a person other than User 136 would likely include formants that are different from formants speech originated by User 136. Machine-generated speech may be detected based on based a rule that machine-generated speech would be more likely to respond artificially (e.g., unnaturally) to system prompts to a putative (e.g., imposter/unauthenticated) User 136. Spoofing attacks may be detected based on a rule that User 136 would not likely engage in an excessive (e.g., above a threshold determined by a continuously trained model for requests generated by a respective User 136) number of document generation requests for different contractees.

Speech Transcriber 188 may evaluate the authenticated speech of a verbal user request to transcribe the spoken words of a user request into text (e.g., electronic code) to generate a transcribed user request. The transcribed user request may express (e.g., by using text) an intent (e.g., to generate a sales contract) and an entity (e.g., which may be a second party whom the sales contract is to involve). The transcribed user request may be expressed as text using the natural language as spoken by the user. However, such language may be unsuitable to be immediately executed or directly inserted into an intended document to be generated.

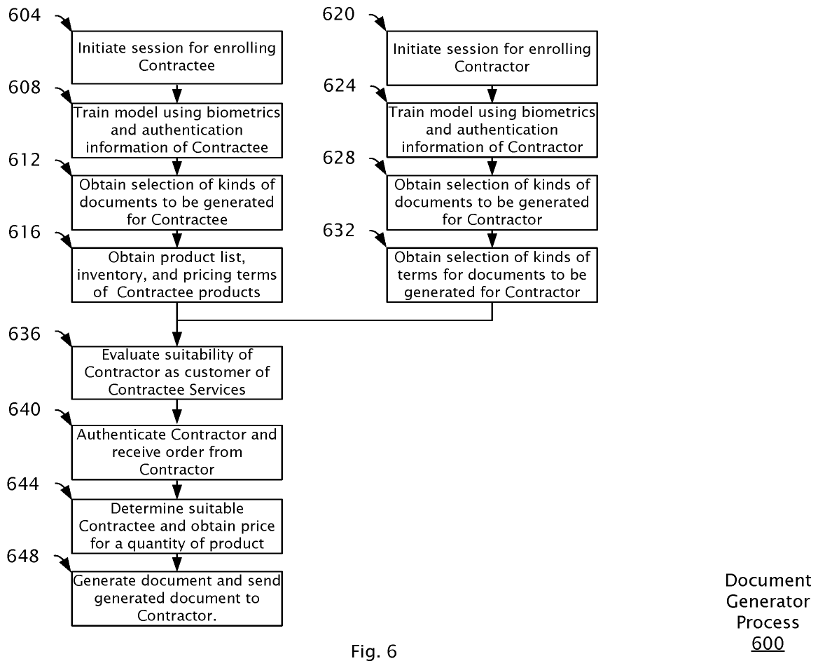

Natural Language Processor 192 may process the transcribed user request to determine an intent and entities (e.g., express, or implied, entities) of the request. Natural Language Processor 192 may determine an intent and entities of the request using natural language processing based on machine leaning-based models and processing of the transcribed user request. An entity may be implicated based on an express mentioning in the user request or based on a context related to the determined intent (e.g., as described herein following and below with reference to FIG. 6). The determined intent and implicated entities may by expressed by Natural Language Processor 192 in a format (e.g., a data structure or descriptive code) which may be interpreted by a cognitive system.

Cognitive System 196 may receive the determined intent and implicated entities as structured information that conveys the determined intent and implicated entities. Cognitive System 196 may include a rules-based expert system or other model/neural network capable of parsing and compiling structured information. The structured information may be received from Natural Language Processor 192 as well as may be received from schema for structurally defining relationships and functions of lexical units (e.g., by showing how selected terms for a document, such as product or entity, are to be used in generating the document) by which Document Generator 104 generates structured documents. By using such systems and techniques, Cognitive System 196 may generate a document based on the determined intent, the implicated entities, and structural information provided by schema. (As used herein, the term schema can be singular, generic, or plural depending on the context used: for example, a schema may include by reference another schema, which in turn may include by reference yet another schema.)

In an example, a user (e.g., a “contractor” or “first party”) may intend to generate a sales contract (e.g., as a document to be generated) with any qualified party (e.g., a suitable party such as a “second party” and/or “contractee”). The particular entity of the qualified party need not be expressly named because the inclusion of an additional entity may be implicated by the rule (e.g., based on the legal definition) that a contract has (at least) two parties. The particular entity to be selected as the qualified party may be determined based on the determining the intent of the user request and based on evaluating a context of the user request. The context may be based on a list of potential contractees kept by the user/contractor, based on a list of potential contractees enrolled by Document Generator 104, based on a list (e.g., blacklist) respectively kept by each of the enrolled contractees, and based on commercial information (such as price, quantity, and availability of a product type). In the description following herein, a user who intends to generate a contract is referred to hereinbelow as a “contractor.”

Before attempting to generate a specific contract, the contractor may locally (e.g., in a LAN or virtual LAN) keep a prioritized list of entities with which it would like to do (or not do) business. The prioritized list may include a value indicating a priority associated with each entity. The value of the priority indicator may be visualized as a “thermometer” having zones for indicating various degrees of desirability of doing business with the respective entity. For example, “higher temperatures” may indicate a stronger desirability, while “temperatures below freezing” may indicate a deprecated desirability (or even a complete lack of desirability). Entities (and their related attributes) may be entered into (or otherwise edited in) the prioritized based on input from the Contractor or automatically input from a third party such as by querying or inputting a government sanctions list. The prioritized list may be organized as a Preferred/Deprecate Contractees List 148.

Storing Preferred/Deprecate Contractees List 148 locally to the contractor allows the contractor to generate and/or edit the list while Device 140 of Contractor 116 is offline. Preferred/Deprecate Contractees List 148 of entities allows contractors to prefer (e.g., include) or to deprecate (e.g., exclude) particular contractees, so that Preferred/Deprecate Contractees List 148 may be protected as proprietary information and/or trade secrets. Document Generator 104 may access Preferred/Deprecate Contractees List 148 associated with each user request (which is to be generated while Device 140 is online). Accordingly, Document Generator 104 need not maintain locally such lists for each of the many different contractors enrolled with Document Generator 104. The decentralized distribution of each respective list of enrolled contractors' priorities helps avoid the situation where a single intrusion (e.g., as part of a successful hacking attempt of Document Generator 104) might be able to access—in a single targetable location and/or by a single breech—proprietary information belonging to any or all of the many different contractors.

Moreover, a contractee may keep a list of “prohibited” contractors with whom it has determined not do business. Entities (and their related attributes) may be entered into (or otherwise edited in) a prioritized list of “prohibited” (or otherwise deprecated) contractors based on input from the Contractee or automatically input from a third party such as by querying or inputting a government sanctions list. A prioritized list of “prohibited” contractors may be organized as Prohibited Contractors List 168. Storing lists of “prohibited” contractors locally to each contractee also provides enhanced security for storing contractee proprietary information because the local storage does not present a single-location risk of breech of the proprietary “prohibited” contractor list. The decentralization of proprietary information enhances security for each user request because Document Generator 104 may arbitrate (e.g., control) each request from each user (e.g., User 136 or 152), which avoids direct communication between any contractor and contractee. Accordingly, Document Generator 104 may set and enforce security policies for each of the arbitrated communications. Avoiding direct communication between any contractor and contractee helps may limit the potential universe of Internet accesses for each contractor or contractee port to a single authorized user (e.g., Document Generator 104). Arranging the Document Generator as a central arbiter between any pair of enrollees (e.g., registered in Registry 180) may enhance the value of the services of Document Generator 104 as being a trusted and “indispensable” go-between for the enrollees. Avoiding direct communication between any contractor and contractee may also help preserve anonymity until such time disclosure of the identity of party would be necessary to generate a final contract. Having Document Generator 104 as a central arbiter helps each contractor and contractee to protect their own lists from disclosure to other enrollees (who may compete with each other), which increases the security and value of each respective party's proprietary information.

After authentication, transcription, and natural language processing occurs as described in the example, Document Generator 104 may select a preferred vendor (e.g., determine a particular contractee as the implicated entity) based on reading a priority indicator associated with each of the potential contractees that are stored in Preferred/Deprecate Contractees List 148. Document Generator 104 may access Preferred/Deprecated Contractees List 148 of the User 136 during an authenticated session, so that (for example) entries in Preferred/Deprecated Contractees List 148 may be protected against disclosure to any of Contractees 124.

In an example, Document Generator 104 may cognitively determine which of Contractees 124 carry (or otherwise resell) in the desired item for sale. Document Generator 104 may poll each of the preferred contractees (as determined by reading from entries Preferred/Deprecated Contractees List 148) to determine availability and pricing of the desired item with respect to each of the preferred contractees being polled. Document Generator 104 may provide an identifier (e.g., a unique identifier) of Contractor 116 and/or User 136 as part of the polling protocol, so that each polled contractee can distinguish the identified Contractor 116 from other contractors that may also attempt to obtain pricing information and availability of a particular desired item. Because each polled contractee can associate the contractor responsible for generating each pricing and availability request, each polled contractee may prevent or reduce “scraping” (e.g., a database dump performed by exhaustively querying a database) by limiting the number of pricing and/or availability requests made by a particular user within a selected time frame (e.g., hourly, daily, weekly, monthly, and other such defined time frames).

In an example, User 136 may request a sales contract to be generated for User 136 to purchase a desired item from an implicated entity. An implicated entity may be a contractee not mentioned by name in the request for a sales contract. In an example, a contractee may be determined/selected to be the implicated entity based on finding a potential contractee that has an inventory that contains a desired item that is subject to the most favorable terms of sale. The terms (e.g., favorable, or otherwise) for the desired item may be obtained in response to a poll (e.g., query) from Document Generator 104, which may be repeated for each enrolled contractee (e.g., each of a selected group of enrolled contractees, where the group is selected by choosing each enrolled contractee that has a priority indicator value above a selection threshold). Each of the enrolled contractees may be polled in order of the priority listed in the Preferred/Deprecated Contractees list. Determining a selected contractor based on the listed priority and based on the favorability of terms may help increase “repeat business” and enhance the goodwill existing between the contractor and a repeatedly selected contractee. The selection of the contractee can be based on determining a weighted result (e.g., determined by weighting each the factors of priority, price, quantity, or availability by their relative importance) for each of the polled contractees and based on comparing each of the determined weighted results against the results for the other polled contractees.

In an example, contractors (and users therefrom) abusing the polling process (e.g., by scraping contractee's database or committing other fraud) can be prohibited from successfully querying a contractee by storing the identifier of the abuser in an exclusion list (e.g., Prohibited Contractors List 168), which may be conveniently stored locally to each contractee. In the example, a contractor making a number of requests to a particular contractee within a predetermined period of time can be given a “timeout” by (e.g., temporarily) storing an identifier of the abusive contractor in Prohibited Contractors list 168 of the particular contractee (e.g., so that attempts by the contractor to reconstruct a particular contractee's price list is substantially slowed down or stopped).

In an example, Document Generator 104 may provide an identifier of the requesting contractor as well as the request for pricing information and availability of a particular desired item. Each polled contractee may decline to fulfill the request based on determining whether the identified requesting contractor is listed in the exclusion list (e.g., Prohibited Contractors List 168) of the polled contractee. In an embodiment, a polled contractee may not disclose to the Document Generator 104 the reason for declined response by the polled contractee. In an embodiment, Document Generator 104 may not disclose to the identified requesting contractor that a particular polled contractee refused to fulfill the request for pricing information and availability of a particular desired item (e.g., so that the polled contractee is not necessarily informed that he/she has been denied services).

Cognitive System 196 of Document Generator 104 may evaluate each of the responses from the polled contractees to determine the response having the most favorable terms. The contractee responding with the most favorable terms can be selected as being suitable for being the entity implicated by the original verbal request. Cognitive System 196 is configured to generate a document based on parties associated with a document (e.g., Contractor 116, which originated the verbal request, and Contractee 128, which is selected in response to offering the most favorable terms). The parties associated with a type of document can be determined based on a reading of a schema that is associated with the determined intent. Cognitive System 196 is configured to select the type of document to be generated based on the intent expressed in the original verbal request.

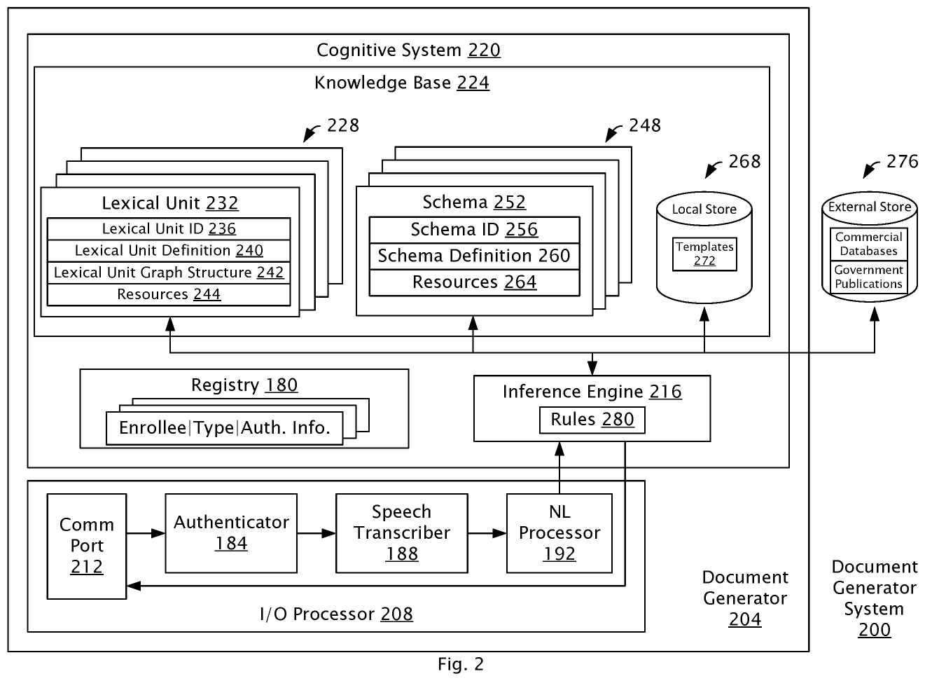

FIG. 2 illustrates Document Generator System 200, according to an embodiment. Document Generator System 200 includes Document Generator 204, which may be networked to External Store 276 (which may include commercial databases such as corporate information and which may also include government publications promulgating law, regulations, codes, procedures, decrees, edicts, proclamations, orders, legislative history and policies, case law, reportings, findings, proceedings, sanction lists, and other authoritative content). Document Generator 204 is a document generator such as Document Generator 104. Document Generator 204 may include Registry 180, I/O processor 208, and Cognitive System 220.

I/O processor 208 includes Communication Port (“Comm Port”) 212, Authenticator 184, Speech Transcriber 188, and Natural Language Processor 192. I/O Processor 208 is configured to send and receive messages across a network (e.g., such as Internet 108). Network messages received at Communication Port 212 may be translated by I/O Processor 208 into a format readable by Inference Engine 216 of the Cognitive System 220. Further, messages received from Inference Engine 216 for transmission to externally networked systems may be formatted by I/O Processor 208 according to a format (e.g., Internet Protocol) that is supported by a network coupled to the Communication Port 212.

Cognitive System 220 includes Inference Engine 216, Knowledge Base 224, and Local Store 268. Inference Engine 216 may be a rules-based engine configured to generate a document based on information received from I/O processor 208 (e.g., a user request having a determined intent) and based on information organized within or referenced by Knowledge Base 224.

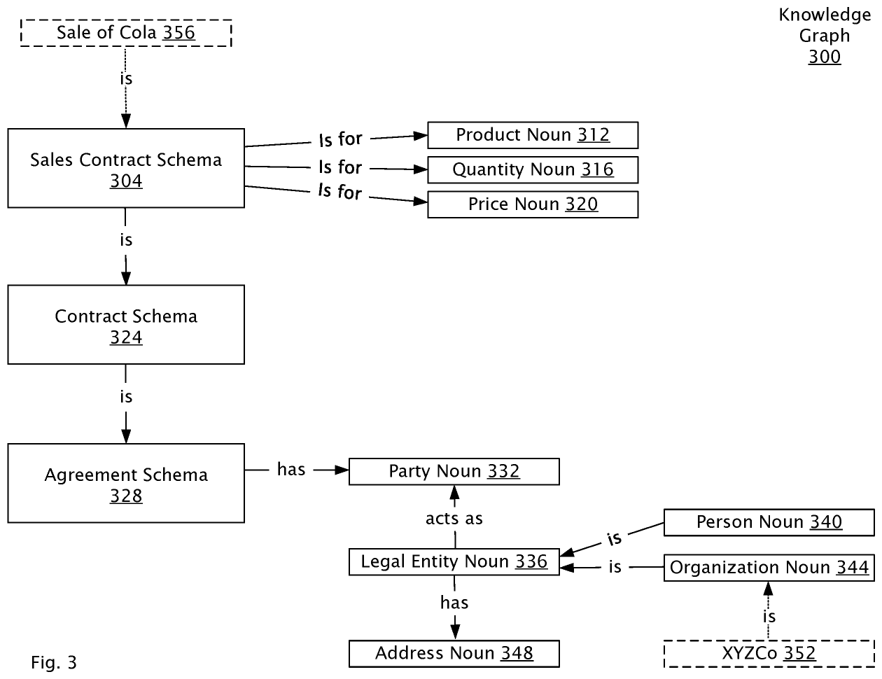

As described hereinbelow with reference to FIG. 3, a document to be generated may be described by a selected arrangement of schemas and lexical units. The schemas and lexical units may be arranged within a knowledge graph to describe and arrange various terms within a document to be generated. The lexical units may include verbs, which may be used to interrelate certain nouns with other nouns. Using verbs to interrelate nouns to form a pair of related nouns may be used to form a notional directed graph (such as a knowledge graph), so that various nouns can be relationally accessed using structural relationships defined by a tree or plex structure. The structural relationships between the nouns may be used to indicate a structure for terms, elements, and related content used for generating a particular kind of document. A directed graph may be traversed by an inference engine and values of the nouns may be evaluated by rules, so that terms of a document (e.g., terms of a legal document) may be automatically set forth, and so that terms, conditions, and obligations of respective parties may be automatically elicited by Document Generator 204. As illustrated in FIG. 2, Knowledge Base 224 includes lexical units 228 and Schemas 248.

Lexical Units 228 is a record structure that includes a list of Lexical Unit 232. Each Lexical Unit 232 includes Lexical Unit Identifier (“Lexical Unit ID”) 236, Lexical Unit Definition 240, Lexical Unit Graph Structure 242, and Resources 244. Lexical Unit 232 may be a noun (e.g., a name for an element to be included in a generated document, or a verb (e.g., a word showing a relationship between nouns or schemas). Lexical Unit Identifier 236 may be a particular word to be used as the particular kind of noun to be included in the generated document, or may be a particular word used to show a particular kind of relationship between nouns, between schemas, and between schemas and nouns. When defining a noun, Lexical Unit Definition 240 may be a kind of noun such as a product noun, quantity noun, price noun, party noun, legal entity noun, address noun, personnel noun, and organization noun. When defining a verb, Lexical Unit Definition 240 may show a kind of relationship between terms such as “term A is a kind of a term B,” “term A is for term B,” “term B acts as term A,” and “term B has term C.” Lexical Unit Graph Structure 242 shows a directional relationship between the particular Lexical Unit 232 being defined and its related terms, such as described hereinbelow with reference to FIG. 3. Resources 244 may include information (e.g., an address or search term) used for obtaining information to be associated with a particular noun or for obtaining information to be associated with a particular kind of relationship between nouns, between schemas, and between schemas and nouns.

Schemas 248 is a record structure that includes Schema 252. Each Schema 252 includes Schema Identifier (“Schema ID”) 256, Schema Definition 260, and Resources 264. Schema 252 may be a portion of a knowledge structure that hierarchically indicates how a particular schema is related to other schema (e.g., where the relationships of schemas within a schema may be used to define the structure of the document based on a user intent). Schema Identifier 256 may be a particular hierarchical class used to determine the kind (e.g., type) of document to be generated. Schema Definition 260 may be a structured description of a hierarchical class that is related hierarchically to other schemas, and which may include Lexical Units 228 that are associated with the Schema 252. Resources 264 may include information (e.g., an address or search term) used for obtaining information to be associated with a particular schema.

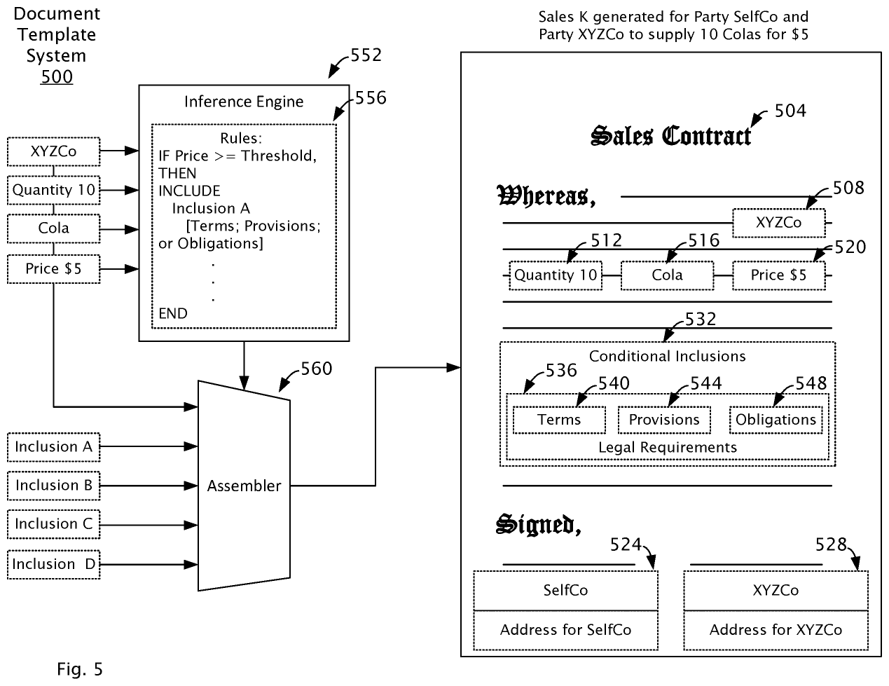

Resources 244 and/or Resources 264 may reference a document template stored in Templates 272 of Local Store 268. A document template may include content (or links to such content) that may be used to populate a generated document. The content may include predetermined content or contractor/contractee-specific information such as document style, formatting, logos, name, address, and other information associated with a selected contractor or contractee. A document template may include rules to determine whether to include (e.g., conditionally include), in the generated document, selected inclusions based on a an evaluation of a rule associated with a particular kind of a noun. In an example, such selected inclusions may include legal language and terms and obligations of a contract based on indications (e.g., confirmations) of noun values received from a contractor and a contractee. (A document template is described hereinbelow with reference to FIG. 5.) Rules 280 may be executed by Inference Engine 216 to generate a document based on a knowledge graph that includes Lexical Units 228 and Schemas 248.

FIG. 3 illustrates Knowledge Graph 300, according to one embodiment. Knowledge Graph 300 is an example directed graph for generating a document such as a sales contract for a sale of cola by a party to a user of Document Generator 104 and/or 204. Knowledge Graph 300 is an example visualization of a structure that includes Lexical Units 228 and Schemas 248.

In an example, Knowledge Graph 300 provides Sales Contract Schema 304. Sales Contract Schema 304 references Product Noun 312, Quantity Noun 316, and Price Noun 320. Product Noun 312, Quantity Noun 316, and Price Noun 320 may be used to describe, respectively, a product for sale, a quantity of the product to be sold, and a price for the quantity of the product to be sold. Each of Product Noun 312, Quantity Noun 316, and Price Noun 320 is arranged using an “Is for” directional relationship with respect to Sales Contract Schema 304.

Sales Contract Schema 304 is arranged using a subordinate “Is” relationship with respect to Contract Schema 324. For example, a sales contract is a kind of a contract, and this relationship is described by the subordination of Sales Contract Schema 304 to Contract Schema 324.

Contract Schema 324 is arranged using a subordinate “Is” relationship with respect to Agreement Schema 328. For example, a contract is a kind of an agreement, and such a relationship is described by the subordination of Contract Schema 324 to Agreement Schema 328.

Agreement Schema 328 references Party Noun 332. Party Noun 332 may be used to identify the party of an agreement. Party Noun 332 is arranged using a “has” directional relationship with respect to Agreement Schema 328 (e.g., “Agreement Schema 328 has Party Noun 332”).

Party Noun 332 references Legal Entity Noun 336. Legal Entity Noun 336 may be used to identify the legal name of a party of an agreement. Legal Entity Noun 336 is arranged using an “act as” relationship with respect to Party Noun 332 (e.g., “Legal Entity Noun 336 acts as Party Noun 332”). Legal Entity Noun 336 can be Person Noun 340 or Organization Noun 344 as shown by the double “is” arrangement extending from each of Person Noun 340 and Organization Noun 344 to Legal Entity Noun 336. Further, Legal Entity Noun 336 may have an address, which is shown by the “has” relationship extending from Legal Entity Noun 336 to Address Noun 348. Various kinds of verbs may be used to establish directional or bidirectional relationships between related terms, where a relationship may be used to describe any kind or property of an instant relationship between related terms (e.g., a relationship between related nouns, a relationship between related schemas, or a relationship between a schema and a related noun).

In operation, Inference Engine 216 traverses each of the elements of Knowledge Graph 300 to determine the hierarchy of the schemas used to generate a document and to determine the information to be obtained for respective values for nouns and schemas of the Knowledge Graph 300. For example, “XYZCo” 352 is an actual name of Organization Noun 344, which in turn is Legal Entity Noun 336 that has Address Noun 348 and acts as Party Noun 332 to Agreement Schema 328. Agreement Schema 328 is Contract Schema, which in turn is Sales Contract Schema 304, which in turn is “Sale of Cola” 356 agreement. The terms “XYZCo” 352 and “Sale of Cola” 356 (as well as Product Noun 312, Quantity Noun 316, and Price Noun 320) may each be determined by based on information given (e.g., spoken) by a user of Document Generator 204.

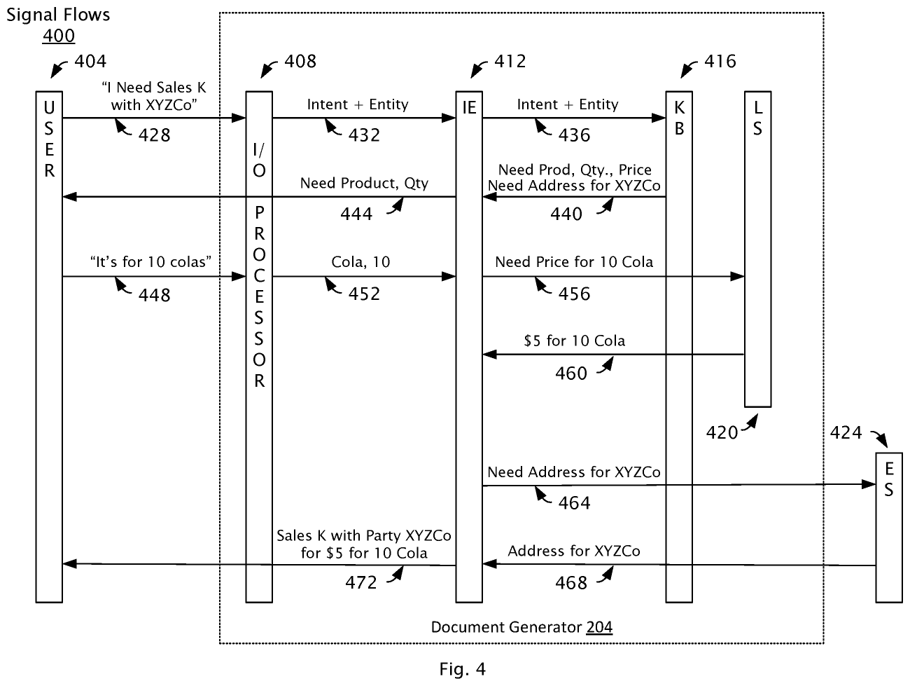

FIG. 4 illustrates Signal Flows 400, according to one embodiment. Signal Flows 400 is a signal flow diagram for generating a document such as a sales contract for a sale of cola by a party to a user of Document Generator 204. Signal Flows 400 is an example information flow for determining values of Lexical Units 228 and Schemas 248 referenced by a knowledge graph such as Knowledge Graph 300.

Signal Flows 400 includes User 404, I/O processor 408, Inference Engine (“IE”) 412, Knowledge Base (“KB”) 416, Local Store (“LS”) 420, and External Store (“ES”) 424. User 404 may be a user such as Contractor 116 and/or User 136. I/O processor 408 may be a processor such as I/O Processor 208. Inference Engine 412 may be an inference engine such as Inference Engine 216. Knowledge Base 416 may be a knowledge base such as Knowledge Base 224. Local Store 420 may be a local store such as Local Store 268. External Store 424 may be external store such as External Store 276.

I/O processor 408, Inference Engine 412, Knowledge Base 416, and Local Store 420 may be located in a single location (e.g., the premises of a business) and may be included by a document generator such as Document Generator 204. User 404 and External Store may each be located in an area remote from the Document Generator 204 and each may separately communicate with the Document Generator 204 using the Internet.

In an example, User 404 establishes a secure connection (e.g., in which User 404 is authenticated, or otherwise verified) with I/O Processor 408. When the secure connection is established, User 404 sends the verbal request “I need a sales contract with XYZCo” to I/O Processor 408 via Message 428. In response, I/O Processor 408 determines (e.g., confirms) an intent and entity of the received verbal request and sends the determined intent and entity to Inference Engine 412 via Message 432. In response, Inference Engine 412 evaluates the determined intent and entity and forwards the determined intent and entity to Knowledge Base 416 via message 436.

Based on the content of message 436, Knowledge Base 416 determines which nouns are to be obtained (e.g., for product quantity and price of a sales contract) and sends a request for obtaining the product, quantity, and price for a sales contract and for obtaining the address of the entity “XYZCo” to Inference Engine 412 via Message 440. Inference Engine 412 determines (e.g., based on executing rules) User 404 is to supply the product and quantity terms and sends message 444 to User 404 requesting values for the product and quantity terms.

In response to message 444, User 404 sends a verbal response “It's for 10 colas” via message 448 to I/O Processor 408. I/O Processor 408 uses natural language processing to extract the term “cola” as being the requested product and to extract the term “10” as being the requested quantity. I/O Processor 408 forwards the extracted terms “cola” and “10” to Inference Engine 412 via Message 452.

Inference Engine 412 determines (e.g., by using rules) Local Store 420 is to supply the price for quantity “10” of product “cola” sold by entity “XYZCo” and sends message 456 to Local Store 420 (which may include an “XYZCo” pricing list) requesting a price for the specified product and quantity terms. In response, Local Store 420 sends Message 460 to Inference Engine 412 indicating the price of “10” units of “Cola” is “$5.”

In response to the Message 440 requesting the address of the entity “XYZCo,” Inference Engine 412 forwards the request to External Store 424 via message 464. External Store 424 may include public and/or private information of entity “XYZCo,” so that address of entity “XYZCo” may be sent to Inference Engine 412 via Message 468.

In response to determining (e.g., confirming) the intent, entity, product, quantity, price, and address information (e.g., as conveyed via messages 460 and 468) Inference Engine 412 generates a sales contract document listing parties to the contract (e.g., User 404 and “XYZCo”), terms of the contract (e.g., “10” units of “Cola” at “$5”), and the address of the entity “XYZCo.” The sales contract document can be generated based on predetermined information stored in a template (as described hereinbelow with respect to FIG. 5). The generated document may be sent to User 404 via Message 472.

FIG. 5 illustrates Document Template System 500, according to one embodiment. Document Template System 500 may include an instance of Templates 272, which are stored in Local Store 268. In an example, Document Template System 500 may be an electronic template for generating a document such as a sales contract for a sale of cola by a party to a user of Document Generator 204.

In this example, Document Template System 500 includes Predetermined Content 504 (such as text and formatting that is generic to sales contracts) and various fields (e.g., Fields 508, 512, 516, 520, 524, and 528) by which, for example, content (such as terms specific to a particular contract) can be merged together with Predetermined Content 504 to generate a customized document as requested by a user of Document Generator 204.

In this example, values determined for Lexical Units 228 and Schemas 248 (such as values determined as described hereinabove with respect to FIG. 4) are merged into Predetermined Content 504 based on positions of respective fields arranged within Predetermined Content 504. Field 508 is associated with Organization Noun “XYZCo,” Field 512 is associated with Quantity Noun “Quantity 10,” Field 516 is associated with Product Noun “Cola,” Field 520 is associated with Price Noun “Price $5,” Field 524 is associated with Organization Noun “SelfCo” and Address Noun “Address for SelfCo,” and Field 528 is associated with Organization Noun “XYZCo” and Address Noun “Address for XYZCo.”

In this example, the generated document may be completed based on the merging of the Predetermined Content 504 together with the values determined for Lexical Units 228 and Schema 248 based on the arrangement of Document Template System 500. In this example, the generated document is a sales contract, which can be stored in Local Store 268, stored in External Store 276, transmitted to Contractor 116, and/or transmitted to Contractee 128.

In this example, Predetermined Content 504 may also be conditionally merged with Conditional Inclusions 532 based on evaluation(s) of values of Nouns associated with the various fields (e.g., Fields 508, 512, 516, 520, 524, and 528). Conditional Inclusions 532 may be content such as a textual description of Legal Requirements 536, which may pertain to a specific kind of legal document (e.g., a sales contract). Legal Requirements 536 may include textual content such as Terms 540, Provisions 544, or Obligations 548 of respective parties to a contract).

For example, the content of Conditional Inclusions 532 (such as terms specific to a particular contract) may be merged together with Predetermined Content 504 to generate a customized document that is customized based on Inference Engine 552 (which may be an Inference Engine such as Inference Engine 216) executing Rules 556 (which may be Rules such as Rules 280) to evaluate values assigned to respective Nouns. In an example, an Inclusion A may be included in the generated contract based on a Price Noun rule being executed to evaluate whether the Price Noun is greater than or equal to a Threshold. The Price Noun rule may include respective indications (e.g., content or pointers to content) for Terms 540, Provisions 544, or Obligations 548 respectively for first and second parties associated with the sales contract to be generated. Content for Conditional Inclusions 532 may be sourced from Local Store 268 or External Store 276, for example.

Document Template System 500 may include Assembler 560, which is configured to conditionally include a selected inclusion for Conditional Inclusions 532. Assembler 560 may include a selected inclusion based on a inclusion command generated by the inference Engine in response to evaluating a rule that, when satisfied or properly evaluated, implicates the inclusion to be selected for inclusion in Conditional Inclusions 532.

A generated contract may be used in various applications to reduce processing requirements when electronically using (e.g., reviewing) a generated document. In an example, a generated contract (e.g., generated in electronic form) may be electronically executed and subsequently electronically filed in court proceedings. In an example, a generated contract may also be stored as an electronic document in a datastore that is accessible to various parties (e.g., such as the first and second parties and other parties granted permission, so that terms of the contract may be queried, and so that terms of the contract and performance of obligations by respective parties thereunto may be automatically tracked and enforced using collaborative work management software. In an example, “forward” links used to include content in the generated contract may be associated with corresponding links of a “reverse” direction, so that the content and locations of content can be later authenticated by traversing the previously included links in the reverse direction. In an example, a generated document may be generated as an electronic document having links (e.g., hyperlinks) based on rules used by an inference generator to determine inclusions of the generated document, so that, for example, a person reviewing an electronic rendering of the generated document can click on (or otherwise select) a term of the generated document and automatically be directed (directly or indirectly) towards authoritative content (such as laws, regulations, procedures, other related contracts, jurisdictions, case law, and identifiers of cognizant parties) to automatically warn, remind, or otherwise inform the reviewer of a legal landscape pertaining to the selected term. In an example, the links generated during the generation of the generated document reduce the processing required otherwise required to performing a forensic analysis at a later time of the generated document. In an example, a reviewer can select a term of a generated electronic document using an electronic browser, and the browser of the electronic contract being reviewed can traverse the directed graph underlying (e.g., used to generate) the electronic contract in order to determine nouns related to a selected noun and display the related nouns (e.g., distantly related nouns) to the reviewer to inform the reviewer of secondary, tertiary, quaternary, and further degrees of relationship of various and numerous kinds of specific nouns that are not easily comprehensible by the human mind (e.g., or by a non-lawyer). In the previous example, the electronic browser may use collaborative work management software to determine obligations of parties related to the selected term and to track performance of the obligations by the related parties. In the previous example, the electronic browser may follow links embedded in the electronic document to determine penalties and legal jeopardies for nonperformance related to content (e.g., laws) related to the selected term.

FIG. 6 illustrates Document Generator Process 600, according to one embodiment. Process 600 may be practiced by processors of Document Generator System 200 operating in a network such as Document Generator Network 100. In an example Process 600, Document Generator 104 may securely enroll a contractor (such as Contractor 116) and a contractee (such as Contractee 128) as authenticatable users and/or entities of Document Generator System 200.

At 604 of Process 600, a session for enrolling a contractee is initiated. For example, a contractee to be enrolled may be a business having products that it offers for sale. The contractee may enroll with Document Generator System 200 by having an authorized representative of the business initiating a secure Internet-enabled session for enrolling the contractees. The secure Internet-enabled session may include video, audio, and keyboard-entered text of the contractee. The authorized representative may be asked to consent to the recording, storing, and use of the authorized representative's personally identifiable information. Based on an affirmative reply, Document Generator System 200 may start collecting and processing personally identifiable information of the authorized representative. A contractee can have other authorized representatives (e.g., associated with an enrollment of the contractee), for which personally identifiable information of each of the other authorized representatives is collected on behalf of the contractee.

At 608 of Process 600, a machine learning-based model is trained using the collected personally identifiable information of the authorized representative. The collected personally identifiable information may include name, address, gestures, voiceprints, video, images, and device fingerprinting. For example, video, audio, and keystrokes of the authorized representative encountered throughout a contractee enrollment session may be monitored and used for training of the machine-learning-based model. The collected personally identifiable information may also be vetted using commercially available business databases and services (e.g., performing a credit check) to help authenticate the identity of the authorized representative.

At 612 of Process 600, a selection of kinds of documents to be generated for which the contractee is to be a party is obtained. The kinds of documents to be generated may include agreements, contracts, sales contracts, and other kinds of documents for which schemas and knowledge graphs have been made available. The kinds of documents made available for selection may be displayed to the authorized representative and the authorized representative may select various kinds of documents to which the contractee agrees (e.g., provisionally agrees) to be made a party. In an embodiment, Document Generator System 200 may store the selected kinds of documents for later use in reducing the amount of processing otherwise used to select a contractee based on an intent conveyed by a user request made by (or confirmed by) a contractor.

At 616 of Process 600, information of products offered by the contractee (such as inventory and pricing of available products) are obtained from the authorized representative of the contractee. In an example, the contractee (e.g., authorized representative of the contractee) may upload a menu that lists available products, quantities of the available products, payment terms, and pricing of the available products based on quantities of the available products to be purchased.

At 620 of Process 600, a session for enrolling a contractor is initiated. For example, a contractor to be enrolled may be a business seeking—from time to time—products for purchasing. The contractor may enroll with Document Generator System 200 by having an authorized user of a contractor initiating an Internet-enabled session for enrolling the contractors. The authorized user may be asked to consent to the recording, storing, and use of personally identifiable information of the authorized representative. Based on an affirmative reply, Document Generator System 200 may start collecting and processing personally identifiable information of the authorized user. A contractor may have other authorized users (e.g., associated with an enrollment of the contractor), for which personally identifiable information of each of the other authorized users of the contractor is collected.

At 624 of Process 600, a machine learning-based model is trained using the collected personally identifiable information of the authorized user. The collected personally identifiable information may include name, address, gestures, voiceprints, video, images, and device fingerprinting. For example, video, audio, and keystrokes of the authorized user encountered throughout a contractor enrollment session may be monitored and used for training of the machine learning-based model. The collected personally identifiable information may also be vetted using commercially available business databases and services (e.g., performing a credit check) to help authenticate the identity of the authorized user of the contractor.

At 628 of Process 600, a selection of kinds of documents to be generated for which the contractor is to be a party is obtained. The kinds of documents to be generated may include agreements, contracts, sales contracts, and other kinds of documents for which schemas and knowledge graphs have been made available. The kinds of documents made available for selection may be displayed to the authorized user and the authorized user may select various kinds of documents to which the contractor agrees (e.g., provisionally agrees) to be made a party. In an embodiment, Document Generator System 200 may store the selected kinds of documents for later use in reducing the amount of processing otherwise used to determine an intent conveyed by a contractor making a user request.

At 632 of Process 600, information relating to terms and conditions are obtained from the authorized user of the contractor. In an example, the contractor may upload or otherwise enter information concerning acceptable delivery windows, payment terms, minimum and maximum amounts for orders of the contractor.

The enrollment of a contractor (e.g., at 620, 624, 628, and 632) may occur before, during, or after the enrollment of a contractee (e.g., at 604, 608, 612, and 616). Generation of a document by the Document Generator System 200 can be initiated at 636 based on the enrollment of a contractee and a contractor.

At 636 of Process 600, the suitability of a contractor to be a customer of contractee (e.g., the suitability of the contractor and contractee being made parties to the same contract) is evaluated. For example, the suitability of the contractor to do business with a contractee may be evaluated by comparing information of the contractee obtained at 616 of Process 600 against information of the contractor obtained at 632 of Process 600. The contractor may be evaluated as being suitable for doing business with the contractee based on the presence of areas of agreement within the compared information obtained at 616 and 632. In the example, the first party may be authorized to generate the document as including a second party based on the evaluation of the contractor as being suitable for doing business with the contractee. Also, for example, the presence of the contractee's name as being listed as being a deprecated contractee in the Preferred/Deprecated Contractee's List 148 and/or the presence of the contractor's name within the Prohibited Contractors List 168 may cause the contractor to be evaluated as being unsuitable for doing business with the contractee.

At 640 of Processor 600, an active session is established with an authenticated contractor and an order is received from the contractor. The contractor may be authenticated by a machine learning-based model previously trained during the enrollment of the contractor. The machine learning-based mode may authenticate a contractor based on its previous training and based on personally identifiable information presently being received from the contractor. The order received from the contractor may be a verbal request, and the verbal request may be authenticated (e.g., as being genuine) by the machine learning-based model based on determining the verbal request was spoken by the authenticated contractor. Authenticating the verbal request as being spoken by the authenticated contractor helps ensure the integrity of the request and helps reduce the possibility of fraud. Provisioning the authentication function as being located within Document Generation System 200 (as compared against locating the authentication function of a device local to the contractor) helps ensure the integrity of the authentication function and provides additional security against replay attacks (e.g., which may be resisted by Document Generation System 200 authenticating the voice carrying the request itself and providing additional authentication challenges such as by varying the content and timing of questions submitted to the contractor).

At 644 of Process 600, a suitable contractee is determined, and a price obtained for a quantity of product. A suitable contractee may be determined based on the context of the user request and contractee information available to Document Generator System 200. The context, for example, may be determined based on the intent and desired product conveyed by the user request. The contractee information, for example, may be used for determining the suitability of the contractee for meeting the contractor's intent and providing the desired product to the contractor.

At 648 of Process 600, a document is generated and sent to the contractor. In an embodiment, Document Generator System can initiate, conduct, and complete electronic execution of the generated document by an authorized party of each of the contractor and contractee. Document Generator System 200 can conduct and complete electronic execution of the generated document by establishing a respective secure session with an authorized party of each of the contractor and the contractee, by displaying the generated document to each authorized party of the contractor and contractee, by prompting for and receiving an electronic signature (or other such approval) indicating approval and acceptance of the generated document by each authorized party of the contractor and contractee, and by generating an electronically signed document by Document Generator System 200 indicating a secured agreement between each authorized party of the contractor and contractee.

One having skill in the art will recognize that various ways of interacting with Document Generator System 200 may be implemented.

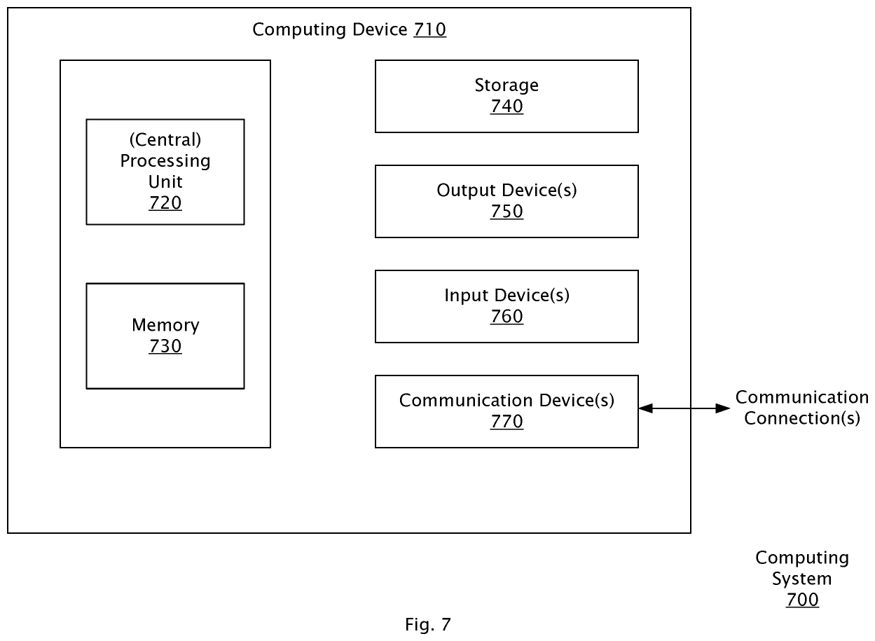

FIG. 7 is a component diagram of computing system 700 to which a process described herein may be applied according to one embodiment. The Computing Device 710 may be utilized to implement one or more computing devices, computer processes, machine learning-based models, neural networks, or software modules described herein, including, for example, but not limited to a mobile device. In one example, the Computing Device 710 may be used to process calculations, execute instructions, and receive and transmit digital signals. In another example, the Computing Device 710 may be utilized to process calculations, execute instructions, receive and transmit digital signals, receive and transmit search queries and hypertext, provide artificial intelligence, and compile computer code suitable for execution on a mobile device. The Computing Device 710 may be any general or special purpose computer now known or to become known capable of performing the steps and/or performing the functions described herein, either in software, hardware, firmware, or a combination thereof.

In a basic configuration, Computing Device 710 typically includes at least one Processing Unit (e.g., CPU) 720 and Memory 730. Depending on the exact configuration and type of Computing Device 710, Memory 730 may be volatile (such as RAM), non-volatile (such as ROM, flash memory, etc.) or some combination of the two. Additionally, Computing Device 710 may also have additional features/functionality. For example, Computing Device 710 may include multiple CPUs. The described methods may be executed in any manner by any processing unit in Computing Device 710. For example, the described process may be executed by both multiple CPUs in parallel.

Computing Device 710 may also include additional storage (removable or non-removable) such as solid-state “hard-drives,” magnetic or optical disks or tape. Such additional storage is illustrated in FIG. 7 by Storage 740. Computer readable storage media include volatile and nonvolatile, removable and non-removable media implemented in any method or technology for storage of information such as computer-readable instructions, data structures, program modules or other data. Memory 730 and Storage 740 are all examples of computer-readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may accessed by Computing Device 710. Any such computer-readable storage media may be part of Computing Device 710. But computer readable storage media do not include transient signals.

Computing Device 710 may also contain Communications Device(s) 770 that allow the device to communicate with other devices. Communications Device(s) 770 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like. Computing Device 710 may also have Input Device(s) 760 such as keyboard, mouse, pen, voice input device, touch input device, etc. Output Device(s) 750 such as a display, speakers, printer, etc. may also be included. Such devices are well known in the art and need not be discussed at length.

Those skilled in the art will realize that storage devices utilized to store program instructions may be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions, may be carried out by a dedicated circuit, such as a digital signal processor (DSP), programmable logic array, or the like.

An example computing system 700 may include a processor communicatively coupled to a computing device; and a memory, coupled to the processor, configured to store executable instructions that, when executed by the processor, cause the processor to: receive a request to generate a contract, the request to generate a contract including a user intent; the contract having a predefined set of legal requirements; select a directed graph based on the user intent, the selected directed graph including nouns and verbs, the nouns for retrievably storing a value for a respective element of the predefined set of legal requirements, and verbs for defining a respective kind of a relationship between each noun of a pair of nouns, where the nouns and the verbs form a structure of the selected directed graph, and where the nouns include a first party noun and a second party noun; traverse, based on the verbs, the structure of the selected directed graph to determine a value for the first party noun and to determine a value for the second party noun; determine a first obligation for the first party noun based on a first element of the predefined set of legal requirements; determine a second obligation for the second party noun based on a second element of the predefined set of legal requirements; and generate the contract based on the first party noun, the first obligation for the first party noun, the second party noun, and the second obligation for the second party noun.

Another example computing system 700 may include a processor communicatively coupled to a computing device; and a memory, coupled to the processor, configured to store executable instructions that, when executed by the processor, cause the processor to: receive a request to generate a contract, the request to generate a contract including a user intent; the contract having a predefined set of legal requirements; select a directed graph based on the user intent, the selected directed graph including nouns and verbs, the nouns for retrievably storing a value for a respective element of the predefined set of legal requirements, and verbs for defining a respective kind of a relationship between each noun of a pair of nouns, where the nouns and the verbs form a structure of the selected directed graph, and where the nouns include a first noun; traverse, based on the verbs, the structure of the selected directed graph to determine a value for the first noun, to evaluate a first noun rule based on the determined value for the first noun, and to determine an inclusion for the first noun based on the evaluation of the first noun rule and based on content associated with the first noun rule; and generate the contract based on the determined value of the first noun and based on the determined inclusion.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further, operations may be performed by a single processing unit or by distributed processing units.

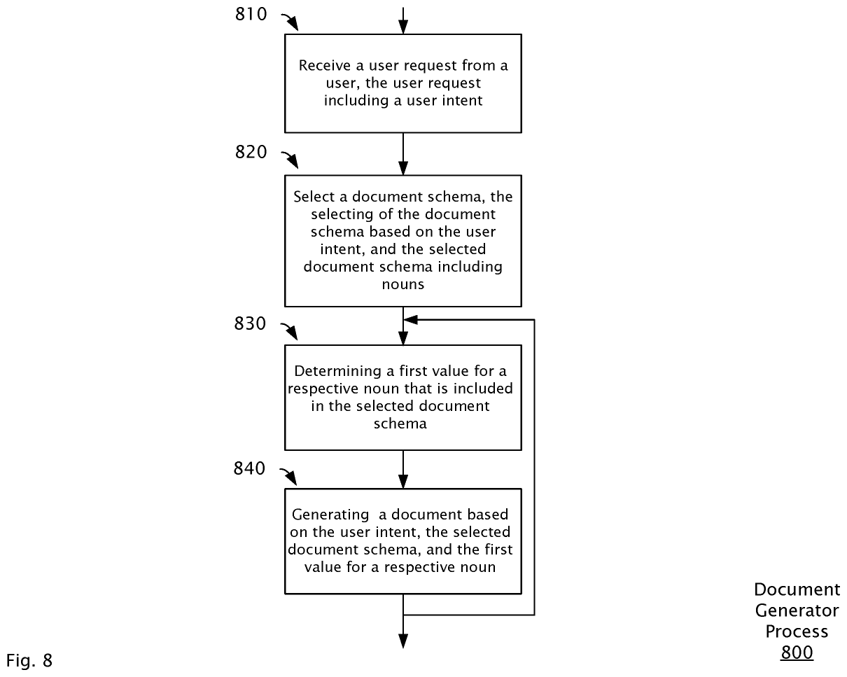

FIG. 8 illustrates Document Generator Process 800 according to another embodiment. In various embodiments Process 800 may be performed by processor executing instructions stored in memory.

At 810 of Process 800, a user request is received from user, where the user request includes a user intent.

At 820 of Process 800, a document schema is selected, where the selecting of the document schema is based on the user intent and is based on the selected document schema including nouns.

At 830 of Process 800, a first value for a respective noun is determined, where the respective noun is a noun that is included in the selected document schema.

At 840 of Process 800, a document is generated based on the user intent, the selected document schema, and the first value for a respective noun. Process 800 may iterate various portions of Process 800, such as by iterating over 830 and 840 to generate additional portions of a document or to generate additional documents.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide complete description of the manufacture and use of the invention. Since many embodiments of the invention may be made without departing from the spirit and scope of the invention, the invention resides in the claims hereinafter appended.

I/We claim:

1. A method for generating documents, the method being performed by a processor executing instructions stored in memory and comprising:
receiving, by the processor, a user request from a user, the user request including a user intent;
selecting, by the processor, a document schema, the selecting of the document schema based on the user intent, and the selected document schema including nouns;
determining, by the processor, a first value for a respective noun, a respective noun being included in the selected document schema; and
generating, by the processor, a document based on the user intent, the selected document schema, and the first value for a respective noun.

2. The method of claim 1, further comprising:
querying, by the processor, the user to provide the first value of a respective noun.

3. The method of claim 1, wherein the user request includes the first value of a respective noun.

4. The method of claim 1, wherein the user request is a request generated using quantifiable voice characteristics of the user.

5. The method of claim 1, further comprising:
quantifying performance characteristics of the user used by the user to generate the user request.

6. The method of claim 5, further comprising:
authenticating the user based on the quantified performance characteristics of the user used by the user to generate the user request.

7. The method of claim 6, wherein the authenticating the user is performed by a model trained based on previously quantified performance characteristics of the user.

8. The method of claim 5, wherein the user is a first party, and further comprising:
authorizing the first party to generate the document as including a second party.

9. The method of claim 8, further comprising:
assigning a name of the user as a username value of a party noun of the selected document schema.

10. The method of claim 9, further comprising:
assigning a name of the second party as a second-party value of a party noun of the selected document schema.

11. The method of claim 10, wherein the assigning of the name of the second party is based on a preferred list stored on a client device local to the first party.

12. The method of claim 11, further comprising:
wherein the assigning of the name of the second party is based on a prohibited list stored remotely from the client device local to the user.

13. The method of claim 10, further comprising:
selecting a template based on the selected document schema, and wherein the generating the document is based on the selected template.

14. The method of claim 10, further comprising:
selecting a template based on the user intent, and wherein the generating the document is based on the selected template.

15. The method of claim 14, further comprising:
wherein the determining the first value is based on querying, by the processor, the user for a value for a noun defined by the selected document schema.

16. The method of claim 15, further comprising:
determining, by the processor, a price value for a respective price noun, a respective noun being included in the selected document schema, the price value being information received from the second party.

17. The method of claim 14, wherein the selected document schema includes a name noun having a value of the second-party name, a quantity name noun having a value of a quantity, a product name noun having a value of a product name, and a price noun having a value of a price, and wherein the generating the document is based on the name noun, the quantity noun, the product noun, and the price noun.

18. The method of claim 17, further comprising:
sending the generated document to the user via the Internet.

19. A server for generating documents, the server comprising:
a processor; and
memory, coupled to the processor, configured to store executable instructions that, when executed by the processor, cause the processor to:
receive a user request from a user, the user request including a user intent;
authenticate the user based on quantifying performance characteristics of the user used by the user to generate the user request;
select a document schema, the selecting of the document schema based on the user intent, and the selected document schema including nouns;
determine a first value for a respective noun, a respective noun being included in the selected document schema; and
generate a document based on the user intent, the selected document schema, and the first value for a respective noun.

20. A system for generating documents, the system comprising:
a processor arranged locally to a server; and
memory, coupled to the processor, configured to store executable instructions that, when executed by the processor, cause the processor to:
receive a user request from a user, the user request including a user intent;
select a document schema, the selecting of the document schema based on the user intent, and the selected document schema including nouns;
authorize the user to generate a document as including a second party assigning a name of the second party as a second-party value of a party noun of the selected document schema, the assigning of the name of the second party being based on a preferred list stored on a client device local to a first party, and the assigning of the name of the second party being based on a prohibited list stored remotely from the client device local to the user;
determine a first value for a respective noun, a respective noun being included in the selected document schema; and
generate a document based on the user intent, the selected document schema, and the first value for a respective noun.

21. A system for generating contracts, the system comprising:
a processor communicatively coupled to a computing device; and
memory, coupled to the processor, configured to store executable instructions that, when executed by the processor, cause the processor to:
receive a request to generate a contract, the request to generate a contract including a user intent; the contract having a predefined set of legal requirements;
select a directed graph based on the user intent, the selected directed graph including nouns and verbs, the nouns for retrievably storing a value for a respective element of the predefined set of legal requirements, and verbs for defining a respective kind of a relationship between each noun of a pair of nouns, where the nouns and the verbs form a structure of the selected directed graph, and where the nouns include a first party noun and a second party noun;
traverse, based on the verbs, the structure of the selected directed graph to determine a value for the first party noun and to determine a value for the second party noun;
determine a first obligation for the first party noun based on a first element of the predefined set of legal requirements;
determine a second obligation for the second party noun based on a second element of the predefined set of legal requirements; and
generate the contract based on the first party noun, the first obligation for the first party noun, the second party noun, and the second obligation for the second party noun.

22. A system for generating contracts, the system comprising:
a processor communicatively coupled to a computing device; and
memory, coupled to the processor, configured to store executable instructions that, when executed by the processor, cause the processor to:
receive a request to generate a contract, the request to generate a contract including a user intent; the contract having a predefined set of legal requirements;
select a directed graph based on the user intent, the selected directed graph including nouns and verbs, the nouns for retrievably storing a value for a respective element of the predefined set of legal requirements, and verbs for defining a respective kind of a relationship between each noun of a pair of nouns, where the nouns and the verbs form a structure of the selected directed graph, and where the nouns include a first noun;
traverse, based on the verbs, the structure of the selected directed graph to determine a value for the first noun, to evaluate a first noun rule based on the determined value for the first noun, and to determine an inclusion for the first noun based on the evaluation of the first noun rule and based on content associated with the first noun rule; and
generate the contract based on the determined value of the first noun and based on the determined inclusion.
